(19) United States
(12) Patent Application Publication
(10) Pub. No.: US 2019/0006062 A1
(43) Pub. Date: Jan. 3, 2019

(54) FOIL STRUCTURE WITH ELECTRICAL FUNCTIONALITY AND EXTERNAL CONTACTING

(71) Applicant: Schreiner Group GmbH & Co. KG, Oberschleissheim (DE)

(72) Inventors: André KALIO, Neubiberg (DE); Sebastian GEPP, Fuerstenfeldbruck (DE); Verena HARTIG, Muenchen (DE); Annette BARTH, Muenchen (DE); Marina WITTENBERG, Ismaning (DE)

(73) Assignee: Schreiner Group GmbH & Co. KG, Oberschleissheim (DE)

(21) Appl. No.: 16/012,883

(22) Filed: Jun. 20, 2018

(30) Foreign Application Priority Data
Jun. 21, 2017 (DE) 10 2017 113 750.5

(51) Int. Cl. H01B 7/00; H01B 17/62; H01B 11/18

(52) U.S. Cl. CPC H01B 7/0018; H01B 11/1834; H01B 17/62

(57) ABSTRACT

A foil structure with electrical functionality and external contacting includes a region containing an electrical transmission path and a contacting region for the external contacting of the electrical transmission path. At least one electrically conductive layer, which is provided with a material mixture of silver and carbon, is contained in the contacting region of the foil structure. The electrically conductive layer can be extended from the contacting region of the foil structure into the region containing the electrical transmission path and can form the electrical transmission path. The electrically conductive layer can be disposed on a conductor track in the contacting region. The electrically conductive layer is mechanically and climatically stable by virtue of the mixture of silver and carbon.

### CROSS REFERENCE TO RELATED APPLICATIONS

Applicant claims priority under 35 U.S.C. § 119 of German Application No. 10 2017 113 750.5 filed Jun. 21, 2017, the disclosure of which is incorporated by reference.

### BACKGROUND OF THE INVENTION

### 1. Field of the Invention

The invention relates to a foil structure with electrical functionality, for example a function as a sensor, and an external contacting, in order to contact an electrically conductive structure, for example a plug, with the foil structure. Furthermore, the invention relates to a method for production of a foil structure with electrical functionality and external contacting.

### 2. Description of the Related Art

Foil structures with electrical functionality generally comprise a carrier foil, on which an electrically conductive layer is disposed as a conductor track. The conductor track is connected at one end to an electrical circuit, which may likewise be disposed on the carrier foil. For example, the electrical circuit may be contained in a radio frequency identification (RFID) chip, which is glued onto the carrier foil. The other end of the conductor track is situated in a contacting region of the foil structure, for example at the rim of the foil structure, and it is used for external contacting of the conductor track or electrical circuit.

The electrically conductive layer is intended to be formed, in the contacting region of the foil structure, in such a way as to be electrically stable toward climate influences and to be mechanically stable, in order to connect a plug, for example a zero insertion force (ZIF) or low insertion force (LIF) plug, several times in succession with the electrically conductive layer, without damaging the electrically conductive layer. For example, the plug is intended to be capable of being plugged into and unplugged again from the foil structure several times, without impairing the electrically conductive layer in the contacting region of the foil structure because of the plug/unplug cycles. Furthermore, it is intended to be possible for the electrically conductive layer in the contacting region of the foil structure to have a high conductivity despite a large number of plug/unplug cycles. Beyond this, the electrically conductive layer is intended to fulfill its function as a contacting layer and to have good electrically conductivity even under the influence of load, meaning when current is present.

Furthermore, it is intended to prevent the electrically conductive layer in the contacting region from becoming corroded under the influence of temperature and humidity, whereby the conductivity in the contacting region of the electrically conductive layer would be lowered.

### SUMMARY OF THE INVENTION

One concern of the present invention is to specify a foil structure with electrical functionality and external contacting, which in the contacting region for the external contacting is formed in such a way as to be electrically stable to climate influences and also to be mechanically stable. Furthermore, it is intended to specify a production method that permits the production of a foil structure with electrical functionality and external contacting, so that the electrically conductive layer in the contacting region is formed in such a way as to be electrically stable to climate influences and to be mechanically stable.

A foil structure with electrical functionality and external contacting, in which an electrically conductive layer is formed in such a way as to be climatically and mechanically robust in the contacting region of the foil structure, is provided in accordance with one aspect of the invention.

The foil structure comprises a region with an electrical transmission path and a contacting region for the external contacting of the electrical transmission path. At least one electrically conductive layer, which is provided with a material mixture of silver and carbon, is contained in the contacting region.

According to a first embodiment of the foil structure, the electrically conductive layer of the contacting region of the foil structure may be extended into the region containing the electrical transmission path. The electrically conductive layer may be provided with a first portion, which is disposed in the contacting region, and with a second portion, which is disposed in the region containing the electrical transmission path. The second portion of the electrically conductive layer forms the electrical transmission path.

The electrically conductive layer may be disposed on a carrier foil both in the contacting region of the foil structure and in the region of the electrical transmission path. The carrier foil is formed as a flexible substrate. In particular, the electrically conductive layer may be disposed directly on the carrier foil. For example, the electrically conductive layer may be overprinted on the carrier foil in the contacting region and also in the region of the transmission path. In the region of the foil structure containing the electrical transmission path, the electrically conductive layer may be covered by an insulating layer. Thereby, that portion of the electrically conductive layer that constitutes the electrical transmission path is protected from external influences.

According to a second embodiment of the foil structure, the foil structure additionally comprises, besides the electrically conductive layer, a conductor track, which is disposed on the carrier foil. The carrier foil is formed as a flexible substrate. The conductor track may be formed as a conductive foil, especially a copper or aluminum foil. The conductor track is disposed on an upper side of the carrier foil both in the region of the foil structure containing the electrically conductive path and in the contacting region of the foil structure.

In the second embodiment of the foil structure, the electrically conductive layer is disposed above the conductor track only in the contacting region of the foil structure. For example, the electrically conductive layer may be disposed directly on the conductor track in the contacting region of the foil structure. In particular, the electrically conductive layer may be overprinted on the conductor track in the contacting region of the foil structure.

In both embodiments of the foil structure, the material mixture of the electrically conductive layer of silver and carbon permits the formation of a scratch-resistant, very highly conductive layer in the contacting region of the foil structure. The material mixture is mechanically stable and permits multiple plug/unplug cycles for plugging of a plug, for example a ZIF or LIF plug, onto the foil structure.

In particular, the carbon content of the mixture ensures that the electrically conductive layer in the contacting region is mechanically robust, especially scratch-resistant, so that a multiple contacting of the foil structure by a plug connector does not lead to direct damage to the electrically conductive layer. The high electrical conductivity of the electrically conductive layer is due in particular to the silver content in the material mixture. By virtue of the high conductivity of the electrically conductive layer, contact resistances at a plug or any other electrical structure that is connected in the contacting region of the foil structure to the electrically conductive layer are low.

In addition, the material mixture of silver and carbon is climatically stable. Thereby the material mixture in the contacting region of the foil structure permits the formation of an electrically conductive layer having an electrically conductive corrosion protection. In the second embodiment, by means of the electrically conductive layer, an electrically conductive corrosion protection is overprinted directly on the conductor track in the contacting region.

In principle, mixing ratios in the entire mixing range of silver and carbon are possible. In other words, the silver content may be greater than 0% and smaller than 100%, and the carbon content may be smaller than 100% and greater than 0%. A material mixture in which the silver content is smaller than 100% and greater than 40% and the carbon content is greater than 0% and smaller than 60% has proved particularly advantageous, especially mechanically robust, for plug applications.

A method for production of the foil structure with electrical functionality and external contacting, in which a contacting region is formed in such a way as to be climatically and mechanically stable, is provided according to embodiments of another aspect of the invention.

The method provides for the creation of a foil structure with a carrier foil, wherein the foil structure is provided with a region having an electrical transmission path and with a contacting region for the external contacting of the electrical transmission path. A material mixture of silver and carbon is prepared. This material mixture is overprinted as an electrically conductive layer above the carrier foil in the contacting region of the foil structure.

For production of the first embodiment of the foil structure, the material mixture of silver and carbon is overprinted directly on the carrier foil in the region of the foil structure containing the electrical transmission path and in the contacting region of the foil structure. The electrically conductive layer forms the electrical transmission path. The entire foil-based sensor may be printed from the material mixture.

For production of the second embodiment of the foil structure, a conductor track is applied onto the carrier foil. The conductor track may be, for example, a conductive foil, especially a copper foil or an aluminum foil, which is disposed on the carrier foil. The conductive foil may be glued onto the carrier foil and then structured as the conductor track by means of etching solutions and/or stamping. The structuring may also be achieved by means of other subtractive methods, for example by use of a laser or by milling. The material mixture of silver and carbon is overprinted directly on the conductor track in the contacting region of the foil structure.

For example, the material mixture of silver and carbon may be overprinted on the carrier foil or on the conductor track by means of screen printing, flexographic printing, inkjet printing or possibly pad printing. The material mixture may also be applied by dispensing. By the use of a printing method for application of the material mixture of silver and carbon on the foil structure, the specified foil structure may be produced in a roll-to-roll manufacturing process or as sheet material.

In the first embodiment, after the preparation of the material mixture of silver and carbon, the electrically conductive layer can be applied on the carrier layer by a single printing step, both in the contacting region and in the region of the foil structure containing the electrical transmission path.

In the second embodiment, the material mixture may be applied directly on the conductor track by a single printing step in the contacting region. When the material mixture of silver and carbon is disposed directly on the conductor track in the contacting region of the foil structure, an electrically conductive corrosion protection, which prevents corrosion of the conductor track, for example of a structured aluminum or copper foil, is achieved in only one process step.

In contrast to an embodiment in which the silver and carbon are printed one over the other as separate courses and for which at least two printing steps are necessary, the production method according to the invention is associated with considerably less effort, namely only with a single printing step for application of the electrically conductive layer.

In a two-layer or multiple-layer printing process, moreover, the occurring printing tolerances would make it difficult or completely impossible to obtain small spacings of the contact terminals in the plug region. Because the specified method is successful with only one single printing step, the narrow register tolerance does not apply, especially for plug-contact spacings (pitches) of ≤1 mm. Furthermore, due to the application of the material mixture of silver and carbon in a single printing step, the method has a shorter process time and smaller reject rate than if a pure silver layer were to be printed first on the carrier foil or the conductor track and a pure carbon layer were to be applied over it in two separate printing steps.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIGS. 1A and 1B show a first embodiment of a foil structure with electrical functionality and external contacting in a cross-sectional view;

FIG. 2 shows an overhead view of a foil structure with electrical functionality and external contacting;

FIG. 3 shows a second embodiment of a foil structure with electrical functionality and external contacting in a cross-sectional view; and

FIG. 4 shows the variation of a layer resistance of a silver/carbon mixture in dependence on a mixing ratio.

### DETAILED DESCRIPTION OF PREFERRED EMBODIMENTS

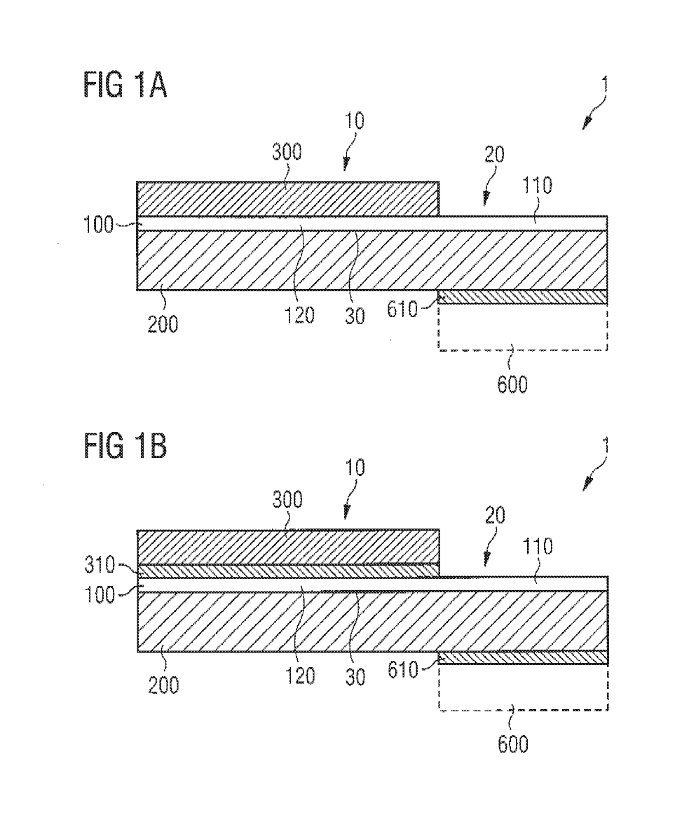

FIGS. 1A and 1B show embodiments of a foil structure 1 with electrical functionality and external contacting in a cross-sectional view. The foil structure 1 is provided with a region 10 having an electrical transmission path 30 and a contacting region 20 for the external contacting of the electrical transmission path 30. At least one electrically conductive layer 100, which is provided with a material mixture of silver and carbon, is contained in the contacting region 20.

In the embodiments of the foil structure 1 shown in FIGS. 1A and 1B, the electrically conductive layer 100 extends from the contacting region 20 into the region 10 of the electrical transmission path 30. The electrically conductive layer 100 is provided with a portion 110, which is disposed in the contacting region 20 of the foil structure 1. Furthermore, the electrically conductive layer 100 comprises a portion 120, which adjoins the portion 110 and is disposed in the region 10 of the foil structure containing the electrical transmission path 30. The electrically conductive layer 100 forms, in the contacting region 20, a contacting layer for the external contacting of the foil structure. In the region 10 of the foil structure, the electrically conductive layer 100 forms the electrical transmission path 30.

The foil structure further comprises a carrier foil 200, which functions as a flexible carrier substrate for the electrically conductive layer 100. The portion 110 and the portion 120 of the electrically conductive layer 100 are disposed on the carrier foil 200. In the embodiment shown in FIG. 1, the two portions 110 and 120 of the electrically conductive layer 100 are disposed directly on the carrier foil 200. The electrically conductive layer 100 may have a layer thickness of, for example, between 3 μm and 30 μm. During use of an inkjet printing method, the electrically conductive layer may even be thinner still, for example may amount to only 0.5 μm. The carrier foil 200 may have a layer thickness of between 25 μm and 500 μm. The carrier foil may be formed as a polyethylene terephthalate (PET), polycarbonate (PC), polyethylene naphthalate (PEN), polyimide (PI) or polyurethane (PU) foil.

In the contacting region 20 of the foil structure, reinforcing layer 600 may be disposed under the carrier foil 200. The reinforcing layer 600 may be formed as a stiffener foil, which by means of an adhesive layer 610 is disposed in the contacting region 20 of the foil structure, on the underside of the reinforcing layer 600. The reinforcing layer may be formed as a PET, PC, PEN, PI or PU foil. The reinforcing layer 600 may have a layer thickness of between 125 μm and 225 μm. By virtue of the reinforcing layer 600, it is possible to even out component tolerances that may be present in a plug housing in which the contacting region 20 of the foil structure is disposed. For most plugs, the total of the foils ranges between 250 μm and 350 μm.

The foil structure 1 further comprises an insulating layer 300. The insulating layer 300 is disposed above the portion 120 of the electrically conductive layer 100, so that the portion 120 of the electrically conductive layer 100 is covered by the insulating layer 300 and thus is protected from external influences. The insulating layer 300 may have a layer thickness of between 1 μm and 175 μm. In contrast, in the contacting region 20 of the foil structure, the electrically conductive layer 100 is uncovered, in order to be connected to an electrical terminal structure.

For example, the insulating layer 300 may be formed as an insulating lacquer, which is disposed on the portion 120 of the electrically conductive layer 100. Such a configuration of the foil structure 1 is illustrated in FIG. 1A. An ultra-violet (UV) lacquer, for example of a UV-curing polymer, or a solvent-based lacquer may be used as the insulating lacquer. According to a further alternative embodiment of the foil structure 1, illustrated in FIG. 1B, the insulating layer may be formed as an insulating foil, especially as a PET, PC, PEN, PI, PU foil or further foil. The insulating foil is joined by means of an adhesive layer 310 to the electrically conductive layer 100.

The contacting region 20 is formed as a region on which the electrically conductive layer 100 may be connected to an electrical terminal structure. For example, the electrical connecting structure may be a plug that is plugged onto the foil structure, for which purpose it may be, for example, a ZIF or LIF plug connector. Thereby an electrical terminal structure in contacting region 20 may be connected removably to the foil structure. Furthermore, the possibility exists of applying a conductive cement on the electrically conductive layer 100 in the contacting region 20, in order thereby to contact an electrical terminal structure, for example a printed circuit board, with the electrically conductive layer 100 of the foil structure. In addition, the possibility exists of creating, in the contacting region 20 of the foil structure, a connection between the foil structure 1 and the electrical terminal structure by crimping, riveting or a similar joining method. The material pair of the connection must be matched to one another.

The use of a material mixture of silver and carbon permits the production, in the contacting region 20, of an electrically conductive layer 100 that is electrically stable to climate influences and is also mechanically stable. Whereas the electrically conductive layer has a high conductivity and thus low contact resistance due to the silver content, a scratch-resistant conductive layer is formed by the addition of carbon to the silver.

Thereby a plug, for example a ZIF or LIF plug, may be connected to the contacting region without significantly damaging the conductive layer 100 in the contacting region 20. By virtue of the mechanical robustness of the electrically conductive layer 100, multiple plug/unplug cycles are possible without significantly damaging the electrically conductive layer 100 in the contacting region 20. A plug may therefore be plugged into and unplugged again from the foil structure several times, without damaging, by abrasion, the first portion 110 of the electrically conductive layer 100 in the contacting region 20 of the foil structure.

The high scratch resistance is imparted in particular by the carbon content of the material mixture. The material mixture of silver and carbon is much more scratch-resistant than if a pure silver paste were to be used in the contacting region 20. The use of a pure carbon paste in the contacting region 20 would likewise have good properties in terms of mechanical stability, but carbon has only a low conductivity. Carbon on its own increases the contact resistance on Al and Cu and reacts with the metal if no gold layer has been introduced in between. In contrast, the use of a material mixture of silver and carbon permits the production of an electrically conductive layer 100 as a mechanically stable, especially scratch-resistant layer with high conductivity.

For the production of the foil structure 1 shown in FIGS. 1A and 1B, a carrier foil 200 is created first of all. Then the material mixture of silver and carbon is prepared. For example, a carbon paste may be additionally mixed in with a silver paste for this purpose. Alternatively, the possibility exists of mixing the carbon and silver particles directly with suitable binders. For example, the carbon and silver particles may be mixed into one paste during production. The material mixture of silver and carbon contains a binder. The paste contains less than 30 wt % of a solvent, especially when a screen-printing method is used. In other methods, the solvent content may also be considerably higher. For application of the material mixture on the carrier foil, a printing method, for example a screen-printing method, a flexographic printing method, a pad-printing method or other method may be used. The material mixture of silver and carbon is overprinted as an electrically conductive layer 100 directly on the carrier foil 200 in the region 10 and also in the contacting region 20 of the foil structure. Furthermore, the possibility exists of applying the material mixture of silver and carbon on the carrier foil by dispensing or by an ink-jet (inkjet) method. The printed silver-carbon mixture may be solvent-based. Alternatively, the silver-carbon mixture may be formed as a layer curable by means of UV light. The layer 100 dries at temperatures between 60° C. and 130° C.

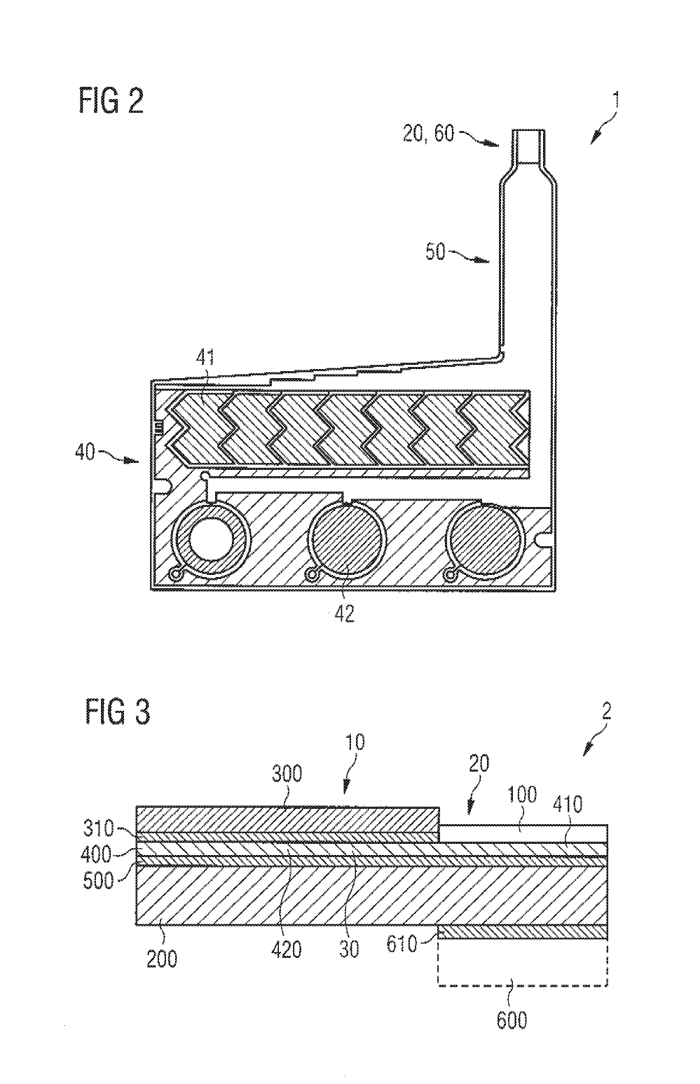

FIG. 2 shows an overhead view of an exemplary embodiment of the foil structure 1. The foil structure is provided with a sensor face 40 having a first sensor region 41 and a second sensor region 42. Furthermore, the foil structure 1 comprises a terminal tab 50, in which a part of the region 10 containing the electrical transmission path is disposed, and a contacting region 20, which is formed as a plug face 60 for plugging in of a plug.

FIG. 3 shows a second embodiment of a foil structure 2 with electrical functionality and external contacting. As in the embodiments of the foil structure shown in FIGS. 1A and 1B, the foil structure 2 comprises a region 10 with an electrical transmission path 30 and a contacting region 20 for the external contacting of the electrical transmission path 30. In the embodiment of the foil structure 2 shown in FIG. 3, the at least one electrically conductive layer 100 is contained only in the contacting region 20. The electrically conductive layer 100 is likewise provided with a material mixture of silver and carbon. The electrically conductive layer 100 may have a layer thickness of, for example, between 0.5 μm and 30 μm.

The foil structure 2 comprises a carrier foil 200, an insulating layer 300 and a conductor track 400. Optionally, a reinforcing layer 600 may be disposed under the carrier foil 200 in the contacting region 20. The reinforcing layer 600 may be formed as described in the first embodiment of the foil structure 1. As in the first embodiment of the foil structure 1, component tolerances in a plug housing or any other receptacle in which the contacting region 20 of the foil structure is disposed may be evened out by the reinforcing layer 600.

The carrier foil 200 is formed as a flexible substrate layer. The layer thickness of the carrier foil 200 usually amounts up to 250 μm. The carrier foil may be formed as a PET, PC, PEN, PI or PU foil. The conductor track 400 is disposed on the carrier foil 200 and is extended from the contacting region 20 into the region 10 of the foil structure containing the electrical transmission path 30. The conductor track 400 may be formed as an aluminum or copper conductor track, for example as an aluminum or copper foil.

The conductor track 400 is provided with a portion 410, which is disposed in the contacting region 20 of the foil structure. Furthermore, the conductor track 400 is provided with a portion 420, which adjoins the portion 410 and is disposed in the region 10 of the foil structure. The portion 420 of the conductor track 400 forms the electrical transmission path 30 in the region 10 of the foil structure 2. The conductor track 400 may contain a conductive metal, especially copper, aluminum or iron, silver, gold, brass (Cu_{y}Znₓ alloy). Instead of a metal, a conductive lacquer, which is applied on the carrier foil 200, may also be used for the conductor track 400. Furthermore, an indium tin oxide (ITO) coating with laser structuring and a Ca/Ag mixture may be used as the contacting. The layer thickness of the conductor track 400 may amount to be between 0.5 μm and 150 μm.

The electrically conductive layer 100 is disposed only on the portion 410 of the conductor track 400. The portion 420 of the conductor track 400 is covered by the insulating layer 300. The insulating layer 300 may be a foil or an insulating lacquer for protection of the conductor track 400 in the region 10 of the foil structure. For simplicity, only one alternative embodiment, in which the insulating layer 300 is formed as a foil, which is glued by means of the adhesive layer 310 onto the portion 420 of the conductor track 400, is shown in FIG. 3. As in the embodiment of the foil structure 1 shown in FIG. 1, the electrically conductive layer 100 is uncovered in the contacting region 20 of the foil structure 2, in order that it can be connected to an electrical terminal structure.

For the production of the foil structure 2 shown in FIG. 3, the carrier foil 200 is created first of all. Then the conductor track 400 is applied on the carrier foil 200. If a conductive metal, for example copper or aluminum, is used for the conductor track 400, the conductor track 400 may be disposed first of all in the form of a metal foil, meaning a copper or aluminum foil, in full-surface manner on the carrier foil 200. For example, such a metal foil may be glued onto the carrier foil 200 by means of the adhesive layer 500 shown in FIG. 3. Alternatively, the conductor track 400 may be vapor-deposited onto the carrier foil 200. The metal foil may then be structured as the conductor track 400 by means of etching solutions and/or stamping.

The material mixture of silver and carbon is then disposed on the portion 410 of the conductor track 400 in the contacting region 20 of the foil structure. The material mixture of silver and carbon may be overprinted on the conductor track 400 especially in the contacting region 20 of the foil structure. For overprinting of the material mixture of silver and carbon on the portion 410 of the conductor track 400, it is possible to use a screen-printing, flexographic or pad-printing method, as in the embodiment of the foil structure 1. Likewise, the possibility exists of applying the material mixture of silver and carbon by dispensing or by means of an ink-jet (inkjet) printing method on the portion 410 of the conductor track 400.

In the region 10 of the foil structure, the insulating layer 300 is applied on the portion 420 of the conductor track 400. In the contacting region 20 of the foil structure, the electrically conductive layer 100 is uncovered, in order that it can be connected to an electrical terminal structure. The electrical terminal structure may be a plug, for example a ZIF or LIF plug, which may be connected removably with the foil structure by plugging onto the contacting region 20. The electrical terminal structure may also be joined to the electrically conductive layer 100 by means of a conductive cement, in liquid form or as adhesive tape, or by crimping.

As explained above, a metal foil, after the gluing onto the carrier foil 200, is structured by means of etching solutions and/or laser treatment/stamping for production of the conductor track 400. The conductor track 400, however, may corrode under the influence of temperature and humidity. In the process, aluminum oxide is formed during use of an aluminum foil as the conductor track 400 and copper oxide is formed during use of a copper foil as the conductor track. In the region 10 of the foil structure, the conductor track 400 is very largely protected from corrosion by virtue of the insulating layer 300. The electrically conductive layer 100 of the material mixture of silver and carbon provided in the contacting region 20 represents an electrically conductive corrosion protection for the portion 410 of the conductor track 400.

The use of a pure carbon paste in the contacting region 20 above the conductor track 400 would lead to a corrosion with the conductor track 400, for example of a metal foil. Furthermore, during use of a pure carbon paste, a considerable increase of resistance in the contacting region 20 occurs due to the corrosion. If pure silver, which would be overprinted, for example, on the carrier foil 200, were to be used for the portion 410 of the conductor track 400, the corrosion protection would indeed exist. Problems with multiple contacting of the foil structure by a plug connector would occur, however, in the contacting region 20 during use of a pure silver layer for the conductor track 400 because printed silver is indeed highly electrically conductive but is not scratch-resistant.

By the use of a material mixture of silver and carbon, it is possible to apply, on the portion 410 of the conductor track 400, an electrically conductive layer 100, in which the corrosive properties of carbon with the underlying conductor track 400 are reduced by virtue of the silver content of the mixture and which is mechanically robust due to the carbon content of the mixture, in order that it can be contacted several times with a plug connector, for example with frog clickers, metal springs or contact pins.

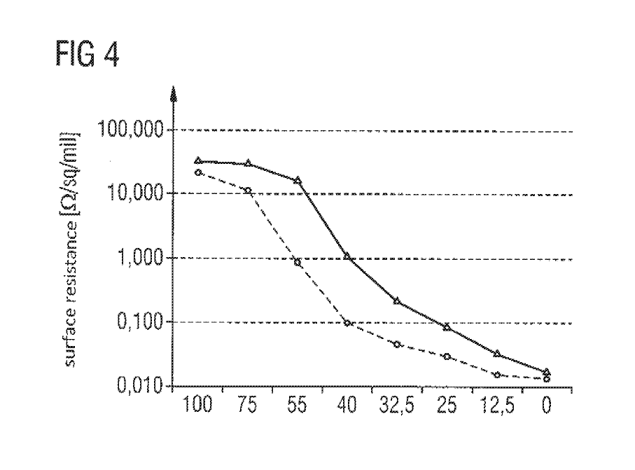

FIG. 4 shows the variation of a surface resistance of the electrically conductive layer 100 in dependence on the mixing ratio of carbon and silver. The carbon content of the mixture is indicated on the x-axis and the resistance in Ω/sq/mil is indicated on the y-axis. The electrical resistance and the electrically conductive layer 100 can be adjusted by the mixing ratio of silver and carbon. In principle, the entire mixing range of silver and carbon may be used for the material mixture of the electrically conducive layer 100, meaning a range of greater than 0% and smaller than 100% for the silver content and correspondingly a range of smaller than 100% and greater than 0% for the carbon content of the mixture.

For production of a mechanically robust electrically conductive layer in the contacting region 20 of the foil structure, a material mixture of silver and carbon with a silver content of smaller than 100% and greater than 40% and with a carbon content of greater than 0% and smaller than 60% has proved to be particularly suitable. An electrically conductive layer 100 of such a material mixture has a high conductivity and is mechanically robust, especially scratch resistant, in order that it will not be significantly damaged even during multiple contacting of the foil structure with a plug.

During use of a copper foil for the conductor track 400, a mixture of 40% carbon and 60% silver printed as a conductive layer on the copper foil has proved particularly suitable for protection against corrosion. A material mixture of 40% carbon and 60% silver for the electrically conductive layer 100, which is printed on a conductor-track portion 410 formed as a copper foil, leads to an absolute resistance change from 0.47Ω to 0.59Ω over 1000 hours at 85° C. and a relative humidity of 85%. During use of an aluminum foil for the conductor track 400, a mixing ratio of 12.5% carbon and 87.5% silver has proved particularly advantageous for the electrically conductive layer 100, with an absolute change of 0.7Ω under identical storage conditions.

Although only a few embodiments of the invention have been shown and described, it is to be understood that many changes and modifications may be made thereunto without departing from the spirit and scope of the invention.

What is claimed is:

1. A foil structure with electrical functionality and external contacting, comprising:
a region with an external transmission path; and
a contacting region for external contacting of the electrical transmission path;
wherein the contacting region contains at least one electrically conductive layer provided with a material mixture of silver and carbon.

2. The foil structure according to claim 1,
wherein the electrically conductive layer extends from the contacting region into the region containing the electrical transmission path; and
wherein the electrically conductive layer comprises a first portion and a second portion adjoining the first portion, wherein the first portion is disposed in the contacting region of the foil structure and the second portion is disposed in the region of the foil structure containing the electrical transmission path and forms the electrical transmission path.

3. The foil structure according to claim 2, further comprising a carrier foil, wherein the first and second portions of the electrically conductive layer are disposed on the carrier foil.

4. The foil structure according to claim 2, further comprising an insulating layer;
wherein the second portion of the electrically conductive layer is covered by the insulating layer.

5. The foil structure according to claim 1, further comprising a conductor track extending from the contacting region into the region of the foil structure containing the electrical transmission path;
wherein the conductor track comprises a first portion and a second portion adjoining the first portion, wherein the first portion is disposed in the contacting region of the foil structure and the second portion is disposed in the region of the foil structure containing the electrical transmission path and forms the electrical transmission path; and
wherein the electrically conductive layer is disposed on the first portion of the conductor track.

6. The foil structure according to claim 5, further comprising a carrier foil;
wherein the first and second portions of the conductor track are disposed on the carrier foil.

7. The foil structure according to claim 5, further comprising an insulating layer;
wherein the second portion of the conductor track is covered by the insulating layer.

8. The foil structure according to claim 1, wherein the electrically conductive layer is disposed in an uncovered manner in the contacting region of the foil structure.

9. The foil structure according to claim 1, wherein the material mixture of silver and carbon has a silver content of greater than 40% and a carbon content of smaller than 60%.

10. A method for producing a foil structure with electrical functionality and external contacting, comprising:
creating a foil structure with a carrier foil, wherein the foil structure is provided with a region having an electrical transmission path and with a contacting region for external contacting of the electrical transmission path;
preparing a material mixture of silver and carbon; and
printing the material mixture as an electrically conductive layer above the carrier foil in the contacting region of the foil structure.

11. The method according to claim 10, wherein the material mixture of silver and carbon is overprinted on the carrier foil in the region of the foil structure containing the electrical transmission path and in the contacting region of the foil structure, wherein the electrically conductive layer forms the electrical transmission path.

12. The method according to claim 11, wherein an insulating layer is applied on the electrically conductive layer in the region of the foil structure containing the electrical transmission path and the electrically conductive layer is disposed in an uncovered manner in the contacting region of the foil structure.

13. The method according to claim 10,
wherein a conductor track is applied on the carrier foil and the conductor track is provided with a first portion and a second portion, wherein the first portion is disposed in the contacting region and the second portion is disposed in the region containing the electrical transmission path, and the second portion of the conductor track forms the electrical transmission path; and
wherein the material mixture of silver and carbon is overprinted on the conductor track in the contacting region of the foil structure.

14. The method according to claim 13, wherein an insulating layer is applied on the conductor track in the region of the foil structure containing the electrical transmission path and the electrically conductive layer is disposed in an uncovered manner in the contacting region of the foil structure.

15. The method according to claim 11, wherein before overprinting on the carrier foil, the material mixture of silver and carbon is mixed with a silver content of greater than 40% and a carbon content of smaller than 60%.
